(19) United States
(12) Patent Application Publication
(10) Pub. No.: US 2009/0172244 A1
(43) Pub. Date: Jul. 2, 2009

(54) HIERARCHICAL SECONDARY RAID STRIPE MAPPING

(76) Inventors: Chaoyang Wang, Cupertino, CA (US); Robert D. Selinger, San Jose, CA (US)

Correspondence Address: PATTERSON & SHERIDAN, L.L.P., 3040 POST OAK BLVD., SUITE 1500, HOUSTON, TX, 77056, US

(21) Appl. No.: 11/968,129

(22) Filed: Dec. 31, 2007

(51) Int. Cl. G06F 12/02

(52) U.S. Cl. 711/5; 711/E12.002

(57) ABSTRACT

Methods and apparatus of the present invention include new data and parity mapping for a two-level or hierarchical secondary RAID architecture. The hierarchical secondary RAID architecture achieves a reduced mean time to data loss compared with a single-level RAID architecture. The new data and parity mapping technique provides load-balancing between the disks in the hierarchical secondary RAID architecture and facilitates sequential access.

### BACKGROUND OF THE INVENTION

1. Field of the Invention

Embodiments of the present invention generally relate to stripe mapping for two levels of RAID (Redundant Array of Inexpensive Disks/Drives), also known as hierarchical secondary RAID (HSR), and more specifically for configurations implementing two levels of RAID 5.

2. Description of the Related Art

Conventional RAID systems configured for implementing RAID 5 store data in stripes with each stripe including parity information. A stripe is composed of multiple strips (also known as elements or the chunk size), with each strip located on a separate hard disk drive. The location of the parity information is rotated for each stripe to load balance accesses for reading and writing data and reading and writing the parity information. FIG. 1A illustrates an example prior art system 100 including a RAID array 130. System 100 includes a central processing unit, CPU 120, a system memory 110, a storage controller 140, and a RAID array 130. CPU 120 includes a system memory controller to interface directly to system memory 110. Storage controller 140 is coupled to CPU 120 via a high bandwidth interface and is configured to function as a RAID 5 controller.

RAID array 130 includes one or more storage devices, specifically N hard disk drive 150(0) and drives 150(1) though 150(N-1) that are configured to store data and are each directly coupled to storage controller 140 to provide a high bandwidth interface for reading and writing the data. The granularity (sometimes referred to as the rank) of the RAID array is the value of N or the equivalently, the number of hard disk drives. The data and parity are distributed across disks 150 using block level striping conforming to RAID 5.

FIG. 1B illustrates a prior art RAID 5 striping configuration for the RAID array devices shown in FIG. 1A. A stripe includes a portion of each disk in order to distribute the data across the disks 150. Parity is also stored with each stripe in one of the disks 150. A left-rotational parity mapping for five disks 150 is shown in FIG. 1B with parity for a first stripe stored in disk 150(4), parity for a second stripe stored in disk 150(3), parity for a third stripe stored in disk 150(2), parity for a fourth stripe stored in disk 150(1), and parity for a fifth stripe stored in disk 150(0). The mapping pattern repeats for the remainder of the data stored in disks 150. Each stripe of the data is mapped to rotationally place data starting at disk 150(0) and repeating the pattern after disk 150(4) is reached. Using the mapping patterns distributes the read and write accesses amongst all of the disks 150 for load-balancing.

When different disk configurations are used in a RAID system, other methods and systems for mapping data and parity are needed for load-balancing and to facilitate sequential access for read and write operations.

### SUMMARY OF THE INVENTION

A two-level, hierarchical secondary RAID architecture achieves a reduced mean time to data loss compared with a single-level RAID architecture as shown in FIG. 1A. In order to provide load-balancing and facilitate sequential access, new data and parity mapping methods are used for the hierarchical secondary RAID architecture.

Various embodiments of the invention provide a method for configuring storage devices in a hierarchical redundant array of inexpensive disks (RAID) system include configuring an array including a primary granularity of storage bricks that each include a secondary granularity of hard disk drive storage devices that store data, primary parity, and secondary parity in stripes in the hierarchical RAID system Secondary parity for each one of the storage bricks is computed from the data that is stored in the secondary stripe within the storage brick. The secondary parity is mapped to one strip of each secondary stripe of the hard disk drives in each one of the storage bricks using a rotational allocation. Primary parity for each primary stripe of the storage bricks is computed from the data that is stored in the primary stripe. The primary parity is mapped to distribute portions of the primary parity to each one of the hard disk drives within each one of the storage bricks.

Various embodiments of the invention provide a system for configuring storage devices in a hierarchical redundant array of inexpensive disks (RAID) system. The system includes an array of storage bricks that each includes a secondary controller that is separately coupled to a set of hard disk drive storage devices configured to store data, primary parity, and secondary parity in stripes and a primary storage controller that is separately coupled to each one of the secondary controllers in the array of storage bricks. The primary storage controller and secondary storage controllers are configured to map the secondary parity for storage in one of the hard disk drives in each of the storage bricks for each secondary stripe using a rotational allocation, wherein the primary parity for each stripe is mapped for storage in one of the hard disk drives in one of the storage bricks.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates an example prior art system including a RAID array.

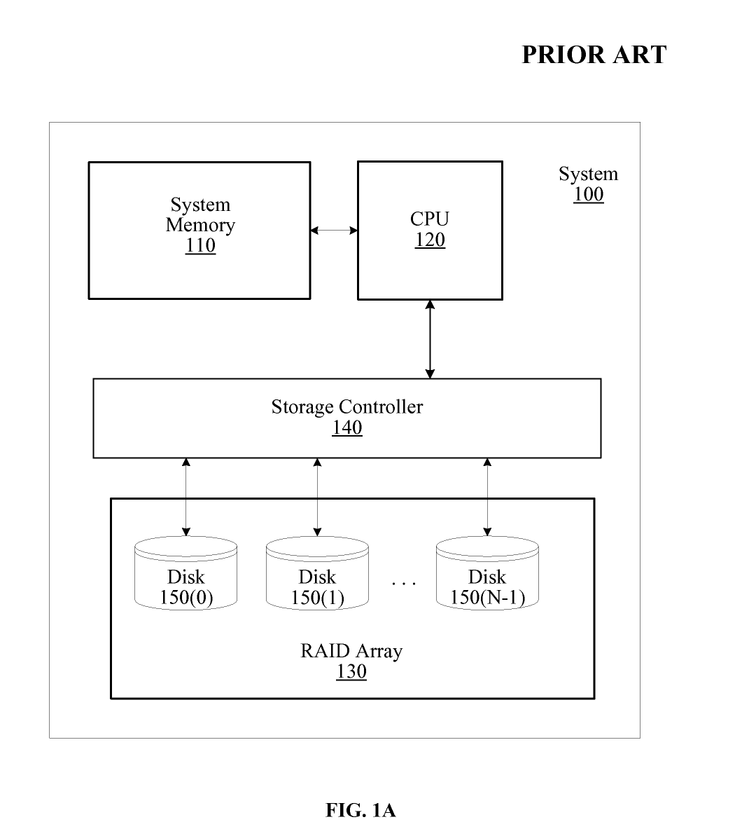

FIG. 1B illustrates a prior art RAID 5 striping configuration for the RAID array devices shown in FIG. 1A.

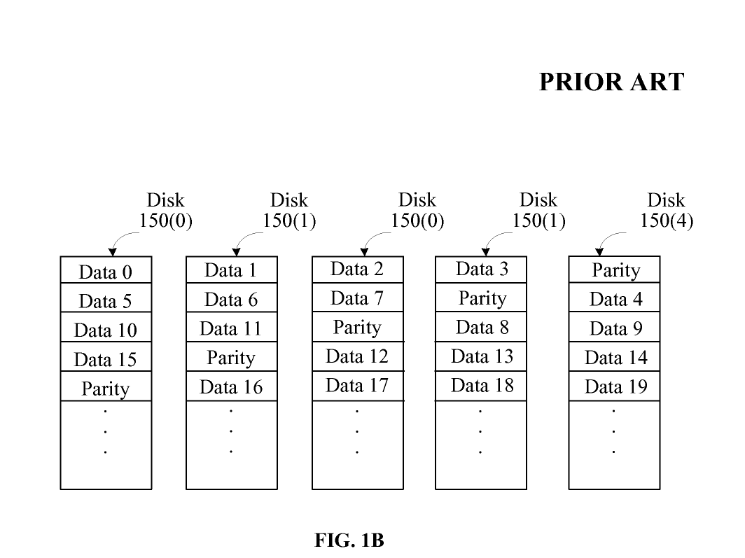

FIG. 2A illustrates a system including an HSR storage configuration, in accordance with an embodiment of the method of the invention.

FIG. 2B illustrates a storage brick of the HSR storage configuration shown in FIG. 2A, in accordance with an embodiment of the method of the invention.

FIG. 3A is an example 3A is an example of conventional RAID 5 mapping used in HSR 55 storage configuration shown in FIG. 2A.

FIG. 3B is another example RAID 5 mapping used in the HSR 55 storage configuration shown in FIG. 2A to produce distributed parity, referred to as “Clustered Parity” in accordance with an embodiment of the method of the invention.

FIG. 3C is a flow chart of operations for mapping the HSR 55 storage configuration for RAID 5, in accordance with an embodiment of the method of the invention.

FIG. 4A is another example RAID 5 mapping used in the HSR 55 storage configuration shown in FIG. 2A, referred to as “Dual Rotating Parity” in accordance with an embodiment of the method of the invention.

FIG. 4B is an example RAID 5 mapping used in the HSR 55 storage configuration when the primary storage controller uses a granularity that is larger than the granularity used by the secondary storage controller, in accordance with an embodiment of the method of the invention.

FIG. 4C is an example RAID 5 mapping used in the HSR 55 storage configuration when the primary storage controller uses a granularity that is smaller than the granularity used by the secondary storage controller, in accordance with an embodiment of the method of the invention.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

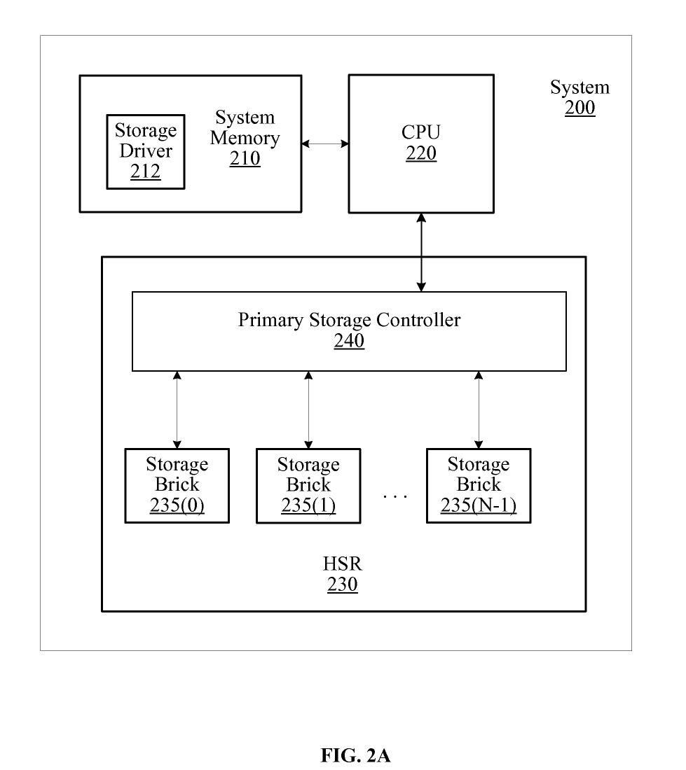

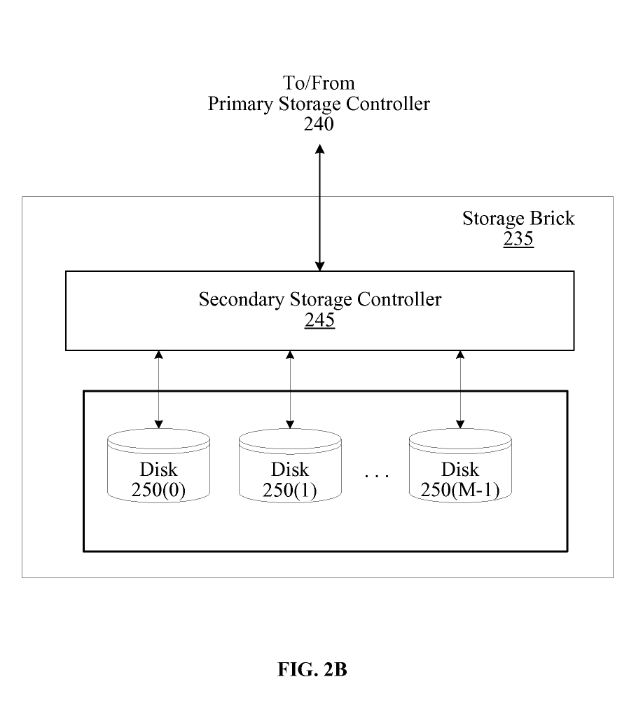

FIG. 2A illustrates a system 200 including a hierarchical secondary RAID storage configuration, HSR 230, in accordance with an embodiment of the method of the invention. System 200 includes a central processing unit, CPU 220, a system memory 210, a primary storage controller 240, and storage bricks 235. System 200 may be a desktop computer, server, storage subsystem, Network Attached Storage (NAS), laptop computer, palm-sized computer, tablet computer, game console, portable wireless terminal such as a personal digital assistant (PDA) or cellular telephone, computer based simulator, or the like. CPU 220 may include a system memory controller to interface directly to system memory 210. In alternate embodiments of the present invention, CPU 220 may communicate with system memory 210 through a system interface, e.g. I/O (input/output) interface or a bridge device.

Primary storage controller 240 is configured to function as a RAID 5 controller and is coupled to CPU 220 via a high bandwidth interface. In some embodiments of the present invention the high bandwidth interface is a standard conventional interface such as a peripheral component interface (PCI). A conventional RAID 5 configuration of storage bricks 235 includes a distributed parity drive and block (or chunk) level striping. In this case, there are N storage bricks 235 and N is the granularity of the primary storage. In other embodiments of the present invention, the I/O interface, bridge device, or primary storage controller 240 may include additional ports such as universal serial bus (USB), accelerated graphics port (AGP), Infiniband, and the like. In other embodiments of the present invention, the primary storage controller 240 could also be host software that executes on CPU 220. Additionally, primary storage controller 240 may be configured to function as a RAID 6 controller in other embodiments of the present invention.

FIG. 2B illustrates a storage brick 235 of the HSR storage configuration shown in FIG. 2A, in accordance with an embodiment of the method of the invention.

Each storage brick 235 includes a secondary storage controller 245 that is separately coupled to storage devices, specifically M hard disk drives 250(0) though 250(M-1), where M is the granularity of the secondary storage. Secondary storage controller 245 provides a high bandwidth interface for reading and writing the data and parity stored on disks 250. Secondary storage controller 245 may be configured to function as a RAID 5 or a RAID 6 controller in various embodiments of the present invention.

If both the primary storage controller 240 and secondary storage controller 245 both implement RAID 5, this is referred to as HSR 55; if the primary storage controller 240 implements RAID 5 and secondary storage controller 245 implements RAID 6, this is referred to as HSR 56; if the primary storage controller 240 implements RAID 6 and secondary storage controller 245 implements RAID 5, this is referred to as HSR 65; and if the primary storage controller 240 implements RAID 6 and secondary storage controller 245 implements RAID 6, this is referred to as HSR 66. In summary, primary storage controller 240 and secondary storage controller 245 can be configured to implement the same RAID levels for HSR 55 and HSR 66 or different RAID levels for HSR 65 and HSR 56.

Each storage device within HSR 230, e.g. bricks 235 and disks 250, may be replaced or removed, so at any particular time, system 200 may include fewer or more storage devices. Primary storage controller 240 and secondary storage controller 245 facilitate data transfers between CPU 220 and disks 250, including transfers for performing parity functions. Additionally, parity computations are performed by primary storage controller 240 and secondary storage controller 245.

In some embodiments of the present invention, primary storage controller 240 and secondary storage controller 245 perform block striping and/or data mirroring based on instructions received from storage driver 212. Each drive 250 coupled to secondary storage controller 245 includes drive electronics that control storing and reading of data and parity within the disk 250. Data and/or parity are passed between secondary storage controller 245 and each disk 250 via a bi-directional bus. Each disk 250 includes circuitry that controls storing and reading of data and parity within the individual storage device and is capable of mapping out failed portions of the storage capacity based on bad sector information.

System memory 210 stores programs and data used by CPU 220, including storage driver 212. Storage driver 212 communicates between the operating system (OS) and primary storage controller 240 secondary storage controller 245 to perform RAID management functions such as detection and reporting of storage device failures, maintaining state data, e.g. bad sectors, address translation information, and the like, for each storage device within storage bricks 235, and transferring data between system memory 210 and HSR 230.

An advantage of a two-level or multi-level hierarchical architecture, such as system 200 is improved reliability compared with a conventional single-level system using RAID 5 or RAID 6. Additionally, storage bricks 235 may be used with conventional storage controllers that implement RAID 5 or RAID 6 since each storage brick 235 appears to primary storage controller 240 as a virtual disk drive. Primary storage controller 240 provides an interface to CPU 220 and additional RAID 5 or RAID 6 parity protection. Secondary storage controller 245 aggregates multiple disks 250 and applies RAID 5 or RAID 6 parity protection. As an example, when five disks 250 (the secondary granularity) are included in each storage brick 235 and five storage bricks 235 (the primary granularity) are included in HSR 230, the capacity equivalent to 16 useful disks of the 25 total disks 250 are available for data storage.

### Conventional Parity Mapping

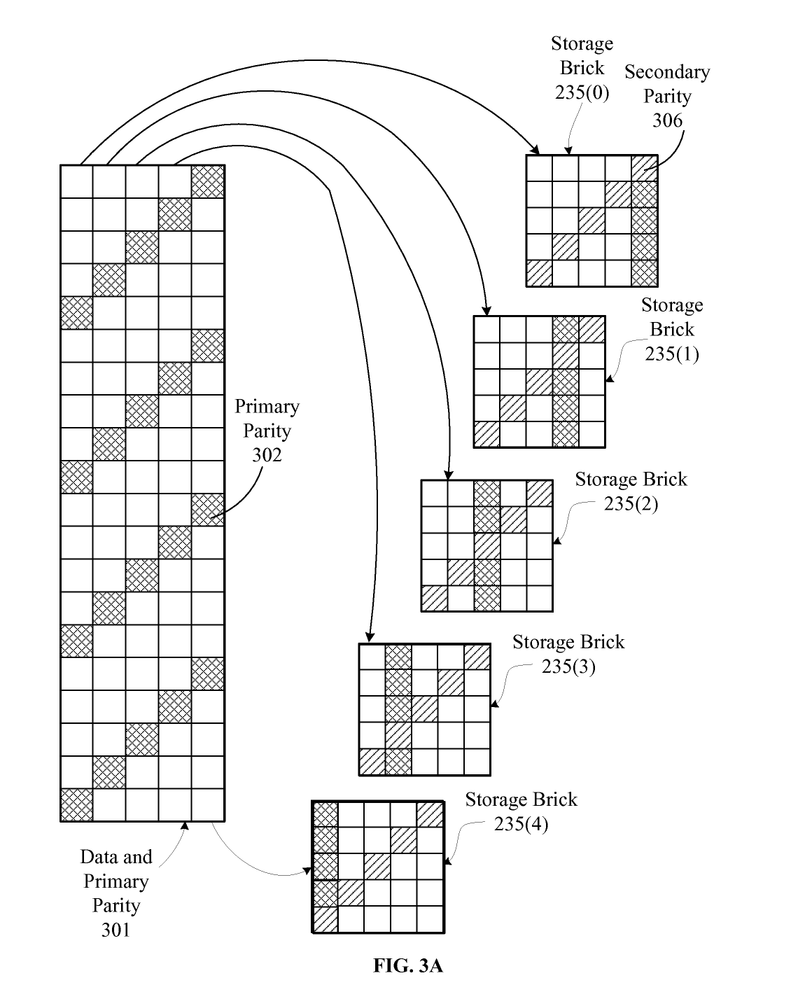

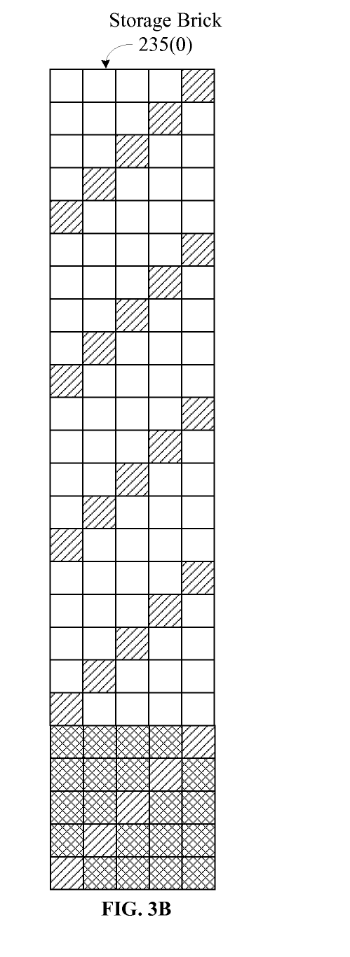

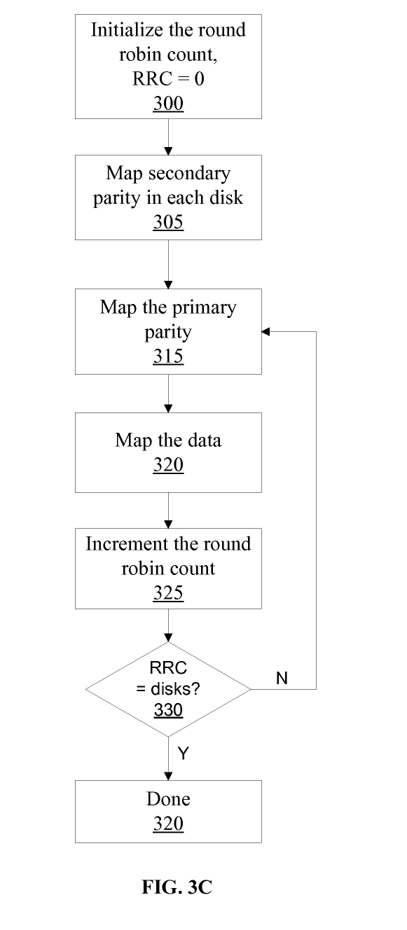

FIG. 3A is an example of conventional RAID 5 striping used in HSR 230 of FIG. 2A. Each small square of data and primary parity 301 and storage bricks 235 corresponds to a single “strip” (a strip is usually 1 or more sectors of a hard disk drive) and a row of strips in each box defines a primary stripe. Each column in the left figure is mapped to a different storage brick 235. A conventional RAID 5 mapping algorithm is applied to both the primary storage, e.g. storage bricks 235 and the secondary storage, e.g. disks 250. In this example each of five storage bricks 235 includes five disks 250. Primary parity is computed for each primary stripe and stored using a “left parity rotation” mapping as shown by the cross-hashed pattern of primary parity 302 in data and primary parity 301. Data and primary parity 301 is a view of the primary parity mapping viewed from primary storage controller 240.

Each column of data and primary parity 301 corresponds to the sequence of strips that is sent to each secondary storage brick 235(0) through 235(4) and mapped into the rows of storage brick 235(0) through 235(4). Each column of data, primary parity and secondary parity in storage brick 235(0) through 235(4) is mapped to a separate disk (250). The rows of storage brick 235(0) through 235(4) are the secondary stripes and secondary parity is computed for each one of the secondary stripes. Secondary storage controller 245 applies conventional RAID 5 mapping using a “left parity rotation” to the sequence of strips from data and primary parity 301 sent from primary controller 240, and computes the secondary parity as shown by the hashed pattern of secondary parity 306. The primary and secondary parity mapping pattern shown for each storage brick 235(0) through 235(4) represents a single secondary mapping cycle that is repeated for the remaining storage in each storage brick 235. When a column of data and primary parity 301 is mapped to one of storage bricks 235, the primary parity is aligned in a single disk 250 within each storage brick 235(0) through 235(4). For example, in storage brick 235(0) the primary parity is aligned in the disk corresponding to the rightmost column. The disks 250 that store the primary parity are hot spots for primary parity updates and do not contribute to data reads. Therefore, the read and write access performance is reduced compared with a mapping that distributes the primary and secondary parity amongst all of disks 250.

As shown in FIG. 3A, only four of each five secondary stripes in disks 250 store primary parity in each secondary mapping cycle. Therefore, one of the five disks 250 in each storage brick 235 does not need to store primary parity for each secondary mapping cycle. The disk 250 that does not store primary parity may be round-robin rotated for each secondary mapping cycle for better load-balancing. When five disks 250 are used, the mapping pattern repeats after five secondary mapping cycles when the round-robin rotation is used.

### Clustered Parity Mapping

FIG. 3B is an example of RAID 5 mapping used in the HSR 55 storage configuration shown in FIG. 2A, to produce distributed primary and secondary parity referred to as “Clustered Parity” in accordance with an embodiment of the method of the invention. As shown in storage brick 235(0), the mapping of secondary parity is rotated for each stripe and the primary parity is mapped in a cluster in the fifth secondary mapping cycle. The primary parity is distributed amongst the disks 250 within each storage brick 235 for improved load-balancing and additional redundancy.

TABLE 1 shows the layout of data as viewed by the primary storage controller 240, with the numbers corresponding to the order of the data strips sent to it by the CPU 220 and “P” corresponding to the primary parity strips. The first 5 columns correspond to storage bricks 235(0) through 235(4).

TABLE 1
data layout viewed from primary storage controller 240

| | | | | |
|---|---|---|---|---|
| 0 | 1 | 2 | 3 | P |
| 5 | 6 | 7 | P | 4 |
| 10 | 11 | P | 8 | 9 |
| 15 | P | 12 | 13 | 14 |
| P | 16 | 17 | 18 | 19 |
| 20 | 21 | 22 | 23 | P |
| 25 | 26 | 27 | P | 24 |
| 30 | 31 | P | 28 | 29 |
| 35 | P | 32 | 33 | 34 |
| P | 36 | 37 | 38 | 39 |
| 40 | 41 | 42 | 43 | P |
| 45 | 46 | 47 | P | 44 |
| 50 | 51 | P | 48 | 49 |
| 55 | P | 52 | 53 | 54 |
| P | 56 | 57 | 58 | 59 |
| 60 | 61 | 62 | 63 | P |
| 65 | 66 | 67 | P | 64 |
| 70 | 71 | P | 68 | 69 |
| 75 | P | 72 | 73 | 74 |
| P | 76 | 77 | 78 | 79 |

TABLE 2 shows the clustered parity layout for HSR 230 in greater detail. The first 5 columns correspond to storage brick 235(0) with columns 0 through 4 corresponding to the five disks 250. The next five columns correspond to storage brick 235(1), and so on. The secondary parity is shown as “Q.” Five hundred strips are allocated in five storage bricks 235 resulting in 20 cycles of primary mapping. The primary parity is stored in a cluster, as shown in the bottom five rows (corresponding to the secondary stripes in disks 250) of TABLE 1. The primary parity is stored in locations 16-19, 36, 56, 76, 116, 136, 156, and so on, as shown in Table 2. In this example, since the granularity of the primary storage is 5, the primary parity is computed for every 4 original strips, and the notation on the parity at the bottom of Table 2 is shortened to denote the first strip in the primary parity, thus 36 denotes the primary parity for strips 36-39.

TABLE 2
Clustered Parity Layout

| 0 | 1 | 2 | 3 | 4 | 5 | 6 | 7 | 8 | 9 | 10 | 11 | 12 |
|---|---|---|---|---|---|---|---|---|---|---|---|---|
| 0 | 5 | 10 | 15 | Q | 1 | 6 | 11 | 16 | Q | 2 | 7 | 12 |
| 25 | 30 | 35 | Q | 20 | 26 | 31 | 36 | Q | 21 | 27 | 32 | 37 |
| 50 | 55 | Q | 40 | 45 | 51 | 56 | Q | 41 | 46 | 52 | 57 | Q |
| 75 | Q | 60 | 65 | 70 | 76 | Q | 61 | 66 | 71 | 77 | Q | 62 |
| Q | 80 | 85 | 90 | 95 | Q | 81 | 86 | 91 | 96 | Q | 82 | 87 |
| 100 | 105 | 110 | 115 | Q | 101 | 106 | 111 | 116 | Q | 102 | 107 | 112 |
| 125 | 130 | 135 | Q | 120 | 126 | 131 | 136 | Q | 121 | 127 | 132 | 137 |
| 150 | 155 | Q | 140 | 145 | 151 | 156 | Q | 141 | 146 | 152 | 157 | Q |
| 175 | Q | 160 | 165 | 170 | 176 | Q | 161 | 166 | 171 | 177 | Q | 162 |
| Q | 180 | 185 | 190 | 195 | Q | 181 | 186 | 191 | 196 | Q | 182 | 187 |
| 200 | 205 | 210 | 215 | Q | 201 | 206 | 211 | 216 | Q | 202 | 207 | 212 |
| 225 | 230 | 235 | Q | 220 | 226 | 231 | 236 | Q | 221 | 227 | 232 | 237 |
| 250 | 255 | Q | 240 | 245 | 251 | 256 | Q | 241 | 246 | 252 | 257 | Q |
| 275 | Q | 260 | 265 | 270 | 276 | Q | 261 | 266 | 271 | 277 | Q | 262 |
| Q | 280 | 285 | 290 | 295 | Q | 281 | 286 | 291 | 296 | Q | 282 | 287 |
| 300 | 305 | 310 | 315 | Q | 301 | 306 | 311 | 316 | Q | 302 | 307 | 312 |
| 325 | 330 | 335 | Q | 320 | 326 | 331 | 336 | Q | 321 | 327 | 332 | 337 |
| 350 | 355 | Q | 340 | 345 | 351 | 356 | Q | 341 | 346 | 352 | 357 | Q |
| 375 | Q | 360 | 365 | 370 | 376 | Q | 361 | 366 | 371 | 377 | Q | 362 |
| Q | 380 | 385 | 390 | 395 | Q | 381 | 386 | 391 | 396 | Q | 382 | 387 |
| 16-19 | 36 | 56 | 76 | Q | 12-15 | 32 | 52 | 72 | Q | 8-11 | 28 | 48 |
| 116 | 136 | 156 | Q | 96 | 112 | 132 | 152 | Q | 92 | 108 | 128 | 148 |
| 216 | 236 | Q | 176 | 196 | 212 | 232 | Q | 172 | 192 | 208 | 228 | Q |
| 316 | Q | 256 | 276 | 296 | 312 | Q | 252 | 272 | 292 | 308 | Q | 248 |
| Q | 336 | 356 | 376 | 396 | Q | 332 | 352 | 372 | 392 | Q | 328 | 348 |
| | 13 | 14 | 15 | 16 | 17 | 18 | 19 | 20 | 21 | 22 | 23 | 24 |
| | 17 | Q | 3 | 8 | 13 | 18 | Q | 4 | 9 | 14 | 19 | Q |
| | Q | 22 | 28 | 33 | 38 | Q | 23 | 29 | 34 | 39 | Q | 24 |
| | 42 | 47 | 53 | 58 | Q | 43 | 48 | 54 | 59 | Q | 44 | 49 |
| | 67 | 72 | 78 | Q | 63 | 68 | 73 | 79 | Q | 64 | 69 | 74 |
| | 92 | 97 | Q | 83 | 88 | 93 | 98 | Q | 84 | 89 | 94 | 99 |
| | 117 | Q | 103 | 108 | 113 | 118 | Q | 104 | 109 | 114 | 119 | Q |
| | Q | 122 | 128 | 133 | 138 | Q | 123 | 129 | 134 | 139 | Q | 124 |
| | 142 | 147 | 153 | 158 | Q | 143 | 148 | 154 | 159 | Q | 144 | 149 |
| | 167 | 172 | 178 | Q | 163 | 168 | 173 | 179 | Q | 164 | 169 | 174 |
| | 192 | 197 | Q | 183 | 188 | 193 | 198 | Q | 184 | 189 | 194 | 199 |
| | 217 | Q | 203 | 208 | 213 | 218 | Q | 204 | 209 | 214 | 219 | Q |
| | Q | 222 | 228 | 233 | 238 | Q | 223 | 229 | 234 | 239 | Q | 224 |
| | 242 | 247 | 253 | 258 | Q | 243 | 248 | 254 | 259 | Q | 244 | 249 |
| | 267 | 272 | 278 | Q | 263 | 268 | 273 | 279 | Q | 264 | 269 | 274 |
| | 292 | 297 | Q | 283 | 288 | 293 | 298 | Q | 284 | 289 | 294 | 299 |
| | 317 | Q | 303 | 308 | 313 | 318 | Q | 304 | 309 | 314 | 319 | Q |
| | Q | 322 | 328 | 333 | 338 | Q | 323 | 329 | 334 | 339 | Q | 324 |
| | 342 | 347 | 353 | 358 | Q | 343 | 348 | 354 | 359 | Q | 344 | 349 |
| | 367 | 372 | 378 | Q | 363 | 368 | 373 | 379 | Q | 364 | 369 | 374 |
| | 392 | 397 | Q | 383 | 388 | 393 | 398 | Q | 384 | 389 | 394 | 399 |
| | 68 | Q | 4-7 | 24 | 44 | 64 | Q | 0-3 | 20 | 40 | 60 | Q |
| | Q | 88 | 104 | 124 | 144 | Q | V84 | 100 | 120 | 140 | Q | 80 |
| | 168 | 188 | 204 | 224 | Q | 164 | 184 | 200 | 220 | Q | 160 | 180 |
| | 268 | 288 | 304 | Q | 244 | 264 | 284 | 300 | Q | 240 | 260 | 280 |
| | 368 | 388 | Q | 324 | 344 | 364 | 384 | Q | 320 | 340 | 360 | 380 |

FIG. 3C is a flow chart of operations for allocating the HSR 230 storage configuration for RAID 5, in accordance with an embodiment of the method of the invention. In step 300 the round-robin count (RRC) indicating the disk 250 in each storage brick 235 that does not store primary parity is initialized to zero. In step 305 the secondary parity is mapped to disks 250. As shown in FIG. 3B, the secondary parity is mapped using a left rotational allocation. In other embodiments of the present invention, other allocations may be used that also distribute the secondary parity amongst disks 250.

In step 315 the primary parity is mapped in one or more clusters, i.e., adjacent secondary stripes, to each of the disks 250 in storage bricks 235. In step 320 the data is mapped to the remaining locations in each of the disks 240 in storage bricks 235 for the current secondary mapping cycle. In step 235 the round-robin count is incremented, and in step 330 the method determines if the round-robin count (RRC) equals the number of disks 250 (M) in each storage brick 235. If the RRC does equal the number of disks 250, then the mapping is complete. Otherwise, the method returns to step 315 to map the primary parity and data for another secondary mapping cycle.

### Dual Rotating Parity Mapping

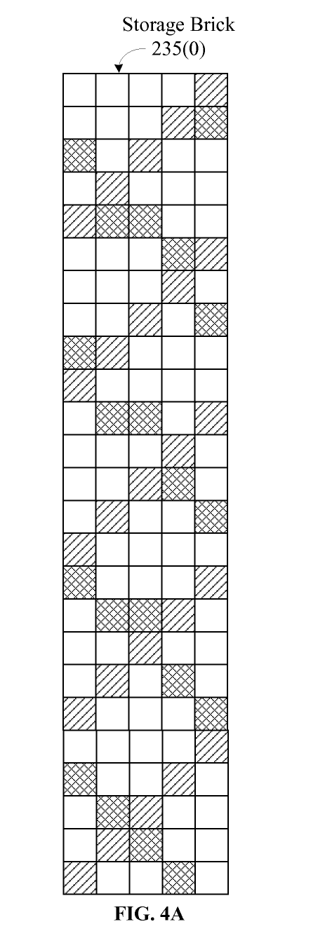

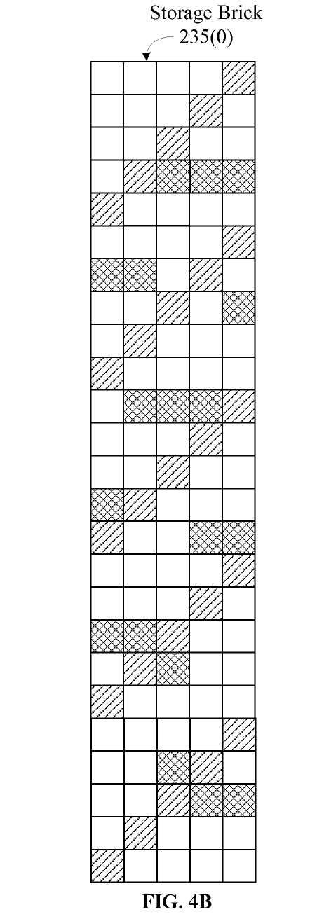

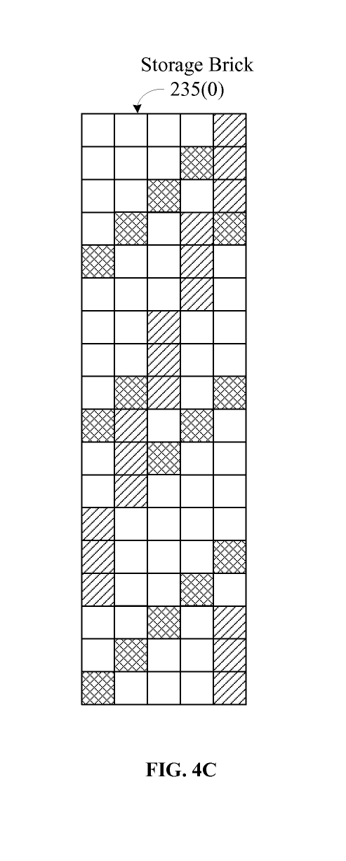

FIG. 4A is another example RAID 5 mapping used in the HSR 55 235 storage configuration shown in FIG. 2A, referred to as “Dual Rotating Parity” in accordance with an embodiment of the method of the invention. Rather than mapping the primary parity in a cluster, the primary parity strips are distributed to non-clustered locations within disks 250 or storage brick 235(0). The mapping shown in FIG. 4A does not waste any disk space and allows the data, primary parity, and secondary parity to be written sequentially since long seek times are not incurred to switch between writing data and parity.

Separate round-robin pointers are used for the mapping of data and primary parity during steps 305 and 315 of FIG. 3C to achieve the mapping allocation shown in FIG. 4A. An additional index for each disk 250 is used to point to the next available location for each secondary mapping cycle. A right round-robin rotation allocation is used for mapping the data and a right round-robin rotation allocation is used for mapping the primary parity shown in FIG. 4A. Note that the mapping of data and primary parity may be rotationally independent. Additionally, the secondary parity may be mapped according to another round-robin rotation allocation.

TABLE 3 shows the right round-robin rotation allocation parity layout for storage brick 235(0) in greater detail. The five columns correspond to the five disks 250 in storage brick 235(0). The secondary parity is shown as “Q.” The primary parity is stored in rotationally allocation locations 4, 9, 14, 19, 24, 29, and so on, as shown in FIG. 4A.

TABLE 3
Round-Robin Rotational Allocation

| 0 | 1 | 2 | 3 | 4 |
|---|---|---|---|---|
| 0 | 1 | 2 | 3 | Q |
| 6 | 7 | 8 | Q | 4 |
| 9 | 13 | Q | 10 | 5 |
| 12 | Q | 15 | 16 | 11 |
| Q | 14 | 19 | 22 | 17 |
| 18 | 20 | 21 | 24 | Q |
| 25 | 26 | 27 | Q | 23 |
| 31 | 32 | Q | 28 | 29 |
| 34 | Q | 33 | 35 | 30 |
| Q | 38 | 40 | 41 | 36 |
| 37 | 39 | 44 | 47 | Q |
| 43 | 45 | 46 | Q | 42 |
| 50 | 51 | Q | 49 | 48 |
| 56 | Q | 52 | 53 | 54 |
| Q | 57 | 58 | 60 | 55 |
| 59 | 63 | 65 | 66 | Q |
| 62 | 64 | 69 | Q | 61 |
| 68 | 70 | Q | 72 | 67 |
| 75 | Q | 71 | 74 | 73 |
| Q | 76 | 77 | 78 | 79 |
| 81 | 82 | 83 | 85 | Q |
| 84 | 88 | 90 | Q | 80 |
| 87 | 89 | Q | 91 | 86 |
| 93 | Q | 94 | 97 | 92 |
| Q | 95 | 96 | 99 | 98 |

TABLE 4 shows the right round-robin rotation allocation parity layout for storage brick 235(0) when six disks 250 are included in storage bricks 235. The six columns correspond to the six disks 250 in storage brick 235(0). The secondary parity is shown as “Q.” The primary parity is stored in rotationally allocation locations 4, 9, 14, 19, 24, 29, and so on.

TABLE 4
Round-Robin Rotational Allocation for 6 disks

| 0 | 1 | 2 | 3 | 4 | 5 |
|---|---|---|---|---|---|
| 0 | 1 | 2 | 3 | 4 | Q |
| 7 | 8 | 10 | 11 | Q | 6 |
| 14 | 16 | 17 | Q | 5 | 9 |
| 15 | 19 | Q | 18 | 12 | 13 |
| 22 | Q | 24 | 26 | 20 | 21 |
| Q | 23 | 25 | 29 | 27 | 28 |
| 30 | 31 | 32 | 33 | 34 | Q |
| 37 | 38 | 40 | 41 | Q | 36 |
| 44 | 46 | 47 | Q | 35 | 39 |
| 45 | 49 | Q | 48 | 42 | 43 |
| 52 | Q | 54 | 56 | 50 | 51 |
| Q | 53 | 55 | 59 | 57 | 58 |
| 60 | 61 | 62 | 63 | 64 | Q |
| 67 | 68 | 70 | 71 | Q | 66 |
| 74 | 76 | 77 | Q | 65 | 69 |
| 75 | 79 | Q | 78 | 72 | 73 |
| 82 | Q | 84 | 86 | 80 | 81 |
| Q | 83 | 85 | 89 | 87 | 88 |
| 90 | 91 | 92 | 93 | 94 | Q |
| 97 | 98 | 100 | 101 | Q | 96 |
| 104 | 106 | 107 | Q | 95 | 99 |
| 105 | 109 | Q | 108 | 102 | 103 |
| 112 | Q | 114 | 116 | 110 | 111 |
| Q | 113 | 115 | 119 | 117 | 118 |
| 120 | 121 | 122 | 123 | 124 | Q |
| 127 | 128 | 130 | 131 | Q | 126 |
| 134 | 136 | 137 | Q | 125 | 129 |
| 135 | 139 | Q | 138 | 132 | 133 |
| 142 | Q | 144 | 146 | 140 | 141 |
| Q | 143 | 145 | 149 | 147 | 148 |

FIG. 4B is an example RAID 5 mapping used in the HSR 55 235 storage configuration when primary storage controller 240 uses a strip size that is larger than the strip size used by secondary storage controller 245, in accordance with an embodiment of the method of the invention. The primary strip size is an integer multiple of the secondary strip size and the primary parity is mapped using a striped distribution that is left round-robin rotation allocation. As shown in FIG. 4B, the integer multiple is three. Separate round-robin pointers are used for the mapping of data and primary parity during steps 305 and 315 of FIG. 3C to achieve the mapping allocation shown in FIG. 4B.

TABLE 4 shows the right round-robin rotation allocation parity layout corresponding to FIG. 4B. The five columns correspond to the five disks 250 in storage brick 235(0) and are labeled in the top row of TABLE 5. The secondary parity is shown as “Q.” The primary parity is stored in rotationally allocation locations −14, −13, −12, −28, −27, and so on.

TABLE 5
Round-robin Rotation Allocation

| 0 | 1 | 2 | 3 | 4 |
|---|---|---|---|---|
| 0 | 1 | 2 | 3 | Q |
| 5 | 6 | 7 | Q | 4 |
| 10 | 11 | Q | 8 | 9 |
| 18 | Q | −14 | −13 | −12 |
| Q | 19 | 15 | 16 | 17 |
| 23 | 24 | 20 | 21 | Q |
| −28 | −27 | 25 | Q | 22 |
| 31 | 32 | Q | 26 | −29 |
| 36 | Q | 33 | 34 | 30 |
| Q | 37 | 38 | 39 | 35 |
| 41 | −44 | −43 | −42 | Q |
| 49 | 45 | 46 | Q | 40 |
| 54 | 50 | Q | 47 | 48 |
| −57 | Q | 51 | 52 | 53 |
| Q | 55 | 56 | −59 | −58 |
| 62 | 63 | 64 | 60 | Q |
| 67 | 68 | 69 | Q | 61 |
| −74 | −73 | Q | 65 | 66 |
| 75 | Q | −72 | 70 | 71 |
| Q | 76 | 77 | 78 | 79 |
| 80 | 81 | 82 | 83 | Q |
| 85 | 86 | −89 | Q | 84 |
| 93 | 94 | Q | 88 | −87 |
| 98 | Q | 90 | 91 | 92 |
| Q | 99 | 95 | 96 | 97 |

FIG. 4C is an example RAID 5 mapping used in the HSR 55 235 storage configuration when primary storage controller 240 uses a strip size that is smaller than the strip size used by secondary storage controller 235, in accordance with an embodiment of the method of the invention. The secondary strip size is an integer multiple of the primary strip size and the primary parity is mapped using a striped left round-robin rotation allocation. As shown in FIG. 4C, the integer multiple is three. Separate round-robin pointers are used for the mapping of data and primary parity during steps 305 and 315 of FIG. 3C to achieve the mapping allocation shown in FIG. 4C. The data and parity is distributed amongst all of disks 250 as shown in FIGS. 4A, 4B, and 4C, for improved load balancing and sequential access compared with using a conventional RAID 5 mapping. Note, that a left round-robin rotation allocation may be used for the primary parity and a right round-robin rotation allocation may be used for the secondary parity. Likewise, a right round-robin rotation allocation may be used for the primary parity and a left round-robin rotation allocation may be used for the secondary parity

TABLE 6 shows the right round-robin rotation allocation parity layout corresponding to FIG. 4C. The five columns correspond to the five disks 250 in storage brick 235(0) and are labeled in the top row of TABLE 6. The secondary parity is shown as “Q.” The primary parity is stored using a rotational allocation in locations −9, −14, −19, −24, −44, and so on.

TABLE 6
Round-robin Rotation Allocation

| 0 | 1 | 2 | 3 | 4 |
|---|---|---|---|---|
| 0 | 1 | 2 | 3 | Q |
| 6 | 7 | 8 | −9 | Q |
| 12 | 13 | −14 | 10 | Q |
| 18 | −19 | 15 | Q | −4 |
| −24 | 20 | 21 | Q | 5 |
| 25 | 26 | 27 | Q | 11 |
| 31 | 32 | Q | 16 | 17 |
| 37 | 38 | Q | 22 | 23 |
| 43 | −44 | Q | 28 | −29 |
| −49 | Q | 33 | −34 | 30 |
| 50 | Q | −39 | 35 | 36 |
| 56 | Q | 40 | 41 | 42 |
| Q | 45 | 46 | 47 | 48 |
| Q | 51 | 52 | 53 | −54 |
| Q | 57 | 58 | −59 | 55 |
| 62 | 63 | −64 | 60 | Q |
| 68 | −69 | 65 | 66 | Q |
| −74 | 70 | 71 | 72 | Q |

The method of mapping the data and primary parity is performed using separate pointers for each disk 250. Pseudo code describing the algorithm for updating the data pointer is shown in TABLE 7, where DP is the device pointer for the data that points to the location that the next data is mapped to. N is the number of secondary storage controllers 245.

TABLE 7

Initialize DP to “0” for RAID5 Left Rotational Mapping allocation,
Increase DP by one (Right Rotation) when new data is mapped,
if DP == N, reset DP to “0”

Pseudo code describing the algorithm for updating the primary parity pointer is shown in TABLE 8, where PP is the device pointer for the primary parity that points to the location that the next primary parity is mapped to.

```
TABLE 8
    Initialize PP according to the logical position of the secondary storage
controller 245 relative to primary storage controller 240
    Increase PP (Right Rotation) or decrease (Left Rotation) by one when
a new primary parity is mapped
    if PP == N (Right Rotation) or DP == −1 (Left Rotation), reset PP to
“0” (Right Rotation) or N (Left Rotation)
```

HSR 230 is used to achieve a reduced mean time to data loss compared with a single-level RAID architecture. The new data, primary parity, and secondary parity mapping technique provides load-balancing between the disks in the hierarchical secondary RAID architecture and facilitates sequential access by distributing the data, primary parity, and secondary parity amongst disks 250.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g. read-only memory devices within a computer such as CD-ROM disks readable by a CD-ROM drive, flash memory, ROM chips or any type of solid-state non-volatile semiconductor memory) on which information is permanently stored; and (ii) writable storage media (e.g. floppy disks within a diskette drive or hard-disk drive or any type of solid-state random-access semiconductor memory) on which alterable information is stored.

While the foregoing is directed to embodiments of the present invention, other and further embodiments of the invention may be devised without departing from the basic scope thereof, and the scope thereof is determined by the claims that follow. The foregoing description and drawings are, accordingly, to be regarded in an illustrative rather than a restrictive sense. The listing of steps in method claims do not imply performing the steps in any particular order, unless explicitly stated in the claim.

The invention claimed is:

1. A method for configuring storage devices in a hierarchical redundant array of inexpensive disks (RAID) system, comprising:
configuring an array including a primary granularity of storage bricks that each include a secondary granularity of hard disk drive storage devices that store data, primary parity, and secondary parity in strips in the hierarchical RAID system;
mapping the secondary parity to one strip of each secondary stripe of the hard disk drives in each one of the storage bricks using a rotational allocation, wherein the secondary parity for each one of the storage bricks is computed from the data that is stored in the secondary stripe within the storage brick; and
mapping the primary parity to distribute portions of the primary parity to each one of the hard disk drives within each one of the storage bricks, wherein the primary parity for each primary stripe of the storage bricks is computed from the data that is stored in the primary stripe.

2. The method of claim 1, wherein the mapping of the primary parity uses a round-robin rotation allocation to distribute portions of the primary parity to each one of the hard disk drives of the storage bricks.

3. The method of claim 2, wherein the round-robin rotation allocation of the secondary parity is a different direction than the round-robin rotation allocation of the primary parity.

4. The method of claim 2, wherein the primary parity is mapped using a left round-robin rotation allocation and the secondary parity is mapped using a right round-robin rotation allocation.

5. The method of claim 2, wherein the primary parity is mapped using a right round-robin rotation allocation and the secondary parity is mapped using a left round-robin rotation allocation.

6. The method of claim 2, wherein the primary parity and the secondary parity are mapped using a single direction of round-robin rotation allocation.

7. The method of claim 1, wherein the primary strip unit is greater than the secondary strip unit and the primary parity is mapped using a round-robin rotation allocation.

8. The method of claim 7, wherein the round-robin rotation allocation of the secondary parity is a different direction than the round-robin rotation allocation of the primary parity.

9. The method of claim 7, wherein the primary parity and the secondary parity are mapped using a single direction of round-robin rotation allocation.

10. The method of claim 1, wherein the mapping of the primary parity allocates clustered storage that is separated from the data and the secondary parity, to distribute portions of the primary parity to each one of the hard disk drives.

11. The method of claim 1, wherein the primary granularity is different than the secondary granularity.

12. The method of claim 1, wherein the secondary strip unit is greater than the primary strip unit and the primary parity is mapped using a round-robin rotation allocation.

13. The method of claim 1, further comprising mapping portions of the data for storage in the hard disk drives in each of the sets for each secondary stripe using a round-robin rotation allocation.

14. A system for configuring storage devices in a hierarchical redundant array of inexpensive disks (RAID) system, comprising:
an array of storage bricks of a primary granularity that each include a secondary controller that is separately coupled to a set of hard disk drive storage devices of a secondary granularity that are configured to store data, primary parity, and secondary parity in stripes; and
a primary storage controller that is separately coupled to each one of the secondary controllers in the array of storage bricks, the primary storage controller and secondary storage controllers configured to:
map the secondary parity for storage in one strip of each secondary stripe of the hard disk drives in each one of the storage bricks using a rotational allocation, wherein the secondary parity for each one of the storage bricks is computed from the data that is stored in the secondary stripe within the storage brick; and
map the primary parity for storage to distribute portions of the primary parity to each one of the hard disk drives within each one of the storage bricks, wherein the primary parity for each primary stripe of the storage bricks is computed from the data that is stored in the primary stripe.

15. The system of claim 14, wherein the primary storage controller and secondary storage controller are further configured to map the primary parity using a round-robin rotation allocation to distribute the portions of the primary parity to each one of the hard disk drives.

16. The system of claim 15, wherein the round-robin rotational allocation of the secondary parity is independent from the round-robin rotation allocation of the primary parity.

17. The system of claim 15, wherein the round-robin rotation allocation of the secondary parity is a different direction than the round-robin rotation allocation of the primary parity.

18. The system of claim 14, wherein the primary storage controller is configured to function using different RAID level than the secondary storage controller.

19. The system of claim 14, wherein the primary storage controller and secondary storage controller are further configured to allocate clustered storage that is separated from the data and the secondary parity to distribute portions of the primary parity to each one of the hard disk drives during the mapping of the primary parity.

20. The system of claim 14, wherein the primary granularity is different than the secondary granularity.
